(19) United States
(12) Patent Application Publication
(10) Pub. No.: US 2013/0211656 A1
(43) Pub. Date: Aug. 15, 2013

(54) AUTONOMOUS DRIVING APPARATUS AND METHOD FOR VEHICLE

(71) Applicants: Kyoung-Hwan AN, Daejeon (KR); Kyung-Bok SUNG, Daejeon (KR); Dong-Yong KWAK, Daejeon (KR)

(72) Inventors: Kyoung-Hwan AN, Daejeon (KR); Kyung-Bok SUNG, Daejeon (KR); Dong-Yong KWAK, Daejeon (KR)

(73) Assignee: ELECTRONICS AND TELECOMMUNICATIONS RESEARCH INSTITUTE, Daejeon-City (KR)

(21) Appl. No.: 13/598,706

(22) Filed: Aug. 30, 2012

(30) Foreign Application Priority Data
Feb. 9, 2012 (KR) 10-2012-0013244

(51) Int. Cl. G05D 1/02

(52) U.S. Cl. 701/25

(57) ABSTRACT

Disclosed herein are an autonomous driving apparatus and method for a vehicle. The autonomous driving apparatus includes an autonomous driving context data processing unit, a simulator unit, a section determination unit, a path planning unit, and a context determination main control unit. The autonomous driving context data processing unit gathers autonomous driving context data. The simulator unit simulates autonomous driving based on the gathered autonomous driving context data. The section determination unit determines a reliable section or an unreliable section based on results of the simulation. The path planning unit searches for at least one global path to a set destination based on results of the determination, and searches the at least one global path for a local path along which the autonomous driving is possible. The context determination main control unit controls the autonomous driving of the vehicle along the local path.

### CROSS REFERENCE TO RELATED APPLICATION

This application claims the benefit of Korean Patent Application No. 10-2012-0013244, filed on Feb. 9, 2012, which is hereby incorporated by reference in its entirety into this application.

### BACKGROUND OF THE INVENTION

1. Technical Field

The present invention relates generally to an autonomous driving apparatus and method for a vehicle and, more particularly, to an autonomous driving apparatus and method for a vehicle, which set reliable sections in which the autonomous driving of a vehicle is possible and autonomously drive the vehicle across the set reliable sections without intervention of a driver.

2. Description of the Related Art

In general, driver-assistant devices provide the function of controlling the speed in a longitudinal direction, like an Adaptive Cruise Control (ACC) system, or the function of assisting driving in a lateral direction, like a Lane Departure Warning System (LDWS) or a Lane Keeping Assist System (LKAS). All such driver-assistant devices are subject to the limitation that the intervention of all drivers in the driver-assistant devices is always required.

Some research into unmanned and autonomous driving vehicles has been done into an unmanned and autonomous driving system that exerts longitudinal and lateral control. However, problems with unmanned and autonomous driving systems are that they are carried out in very limited environments and they do not guarantee reliability on real roads. For example, if the map data inside a vehicle does not match the real environment because of a shadow region in which a Global Positioning System (GPS) does not work or because of road construction, unmanned and autonomous driving is difficult.

Since there are many cases where it is almost impossible to make predictions in a real road environment as described above, there is a need for a specific device that enables autonomous driving to be performed in previously verified areas for safety's sake. There is also a need for a method of overcoming the problem of the areas in which autonomous driving is possible and is not possible are different for each vehicle and depending on driving conditions because of differences in the sensors of vehicles, differences in the computer power of vehicles, differences in the map data of vehicles, or differences in the weather and time span.

### SUMMARY OF THE INVENTION

Accordingly, the present invention has been made keeping in mind the above problems occurring in the prior art, and an object of the present invention is to provide an autonomous driving apparatus and method for a vehicle, which set reliable sections in which the autonomous driving of a vehicle is possible and autonomously drive the vehicle within the set reliable sections without intervention of a driver.

In order to accomplish the above object, the present invention provides an autonomous driving method for a vehicle, including obtaining a current position of the vehicle and setting a destination of the vehicle; searching paths, ranging from the current position of the vehicle to the destination, for an autonomous driving global path having a reliable section; periodically obtaining a position of the vehicle moving along the autonomous driving global path; if the obtained position falls within a set error range, determining whether the vehicle has reached the destination based on results of matching the position of the vehicle with a map; if, as a result of the determination, it is determined that the vehicle has not reached the destination, obtaining a current link and a subsequent link of the vehicle and determining whether the subsequent link corresponds to a reliable section; and if, as a result of the determination, it is determined that the subsequent link is a reliable section, controlling driving of the vehicle so that the vehicle is moved by autonomous driving.

The reliable section may correspond to a spatial-temporal section in which autonomous driving context data obtained on a specific road satisfies conditions required for the autonomous driving.

The controlling the driving of the vehicle may include, if, as a result of the determination, it is determined that the subsequent link is a reliable section, determining whether the vehicle is now moving under autonomous driving; if, as a result of the determination, it is determined that the vehicle is now being moved by the autonomous driving, obtaining autonomous driving context data using sensors of the vehicle or from an external infrastructure; running simulation based on the autonomous driving context data; planning an autonomous driving local path based on results of the simulation; and controlling the driving of the vehicle based on the autonomous driving local path.

The determining whether the vehicle is now moving under autonomous driving may include, if, as a result of the determination, it is determined that the vehicle is not now being moved by the autonomous driving, informing a vehicle driver that the vehicle is located in an area in which the autonomous driving is possible.

The autonomous driving context data may correspond to data required for the autonomous driving of the vehicle, and may include at least one of a data gathering time, a gathering position, a Global Positioning System (GPS) context, lane recognition information, matching with stored 3D map information, static/dynamic obstacle detection information, signal lamp recognition information, signpost recognition information, weather, each link average driving speed, and driver manipulation information.

The autonomous driving method may further include, if, as a result of the determination, it is determined that the periodically obtained position falls within the set error range, obtaining a prediction link based on the results of matching the position of the vehicle with the map; and if, as a result of the determination, it is determined that the vehicle is now being moved by the autonomous driving, requesting manual driving from a vehicle driver so that the driver manually drives the vehicle.

The requesting the manual driving from the vehicle driver may include, if the vehicle is not manually moved by the driver within a set time after the manual driving has been requested, controlling the vehicle so that the vehicle is parked at a side of a road.

In order to accomplish the above object, the present invention provides an autonomous driving apparatus for a vehicle, including an autonomous driving context data processing unit for gathering autonomous driving context data; a simulator unit for simulating autonomous driving of the vehicle based on the gathered autonomous driving context data; a section determination unit for determining a reliable section or an unreliable section of a road based on results of the simulation of the autonomous driving of the vehicle; a path planning unit for searching for at least one global path along which the vehicle moves from a current position to a set destination based on results of the determination of the reliable section or the unreliable section, and searching the at least one global path for a local path along which the autonomous driving is possible; and a context determination main control unit for controlling the autonomous driving of the vehicle along the local path.

The autonomous driving context data may correspond to data required for the autonomous driving of the vehicle, and may include at least one of a data gathering time, a gathering position, a GPS context, lane recognition information, matching with stored 3D map information, static/dynamic obstacle detection information, signal lamp recognition information, signpost recognition information, weather, each link average driving speed, and driver manipulation information.

The autonomous driving context data processing unit may include a vehicle autonomous driving context data processing unit for gathering the autonomous driving context data using sensors of the vehicle; and an infrastructure autonomous driving context data processing unit for gathering the autonomous driving context data based on an external infrastructure.

The reliable section may correspond to a spatial-temporal section in which the autonomous driving context data of the road satisfies conditions required for the autonomous driving.

The unreliable section may correspond to a GPS shadow region in which reception of GPS signals is impossible while a vehicle is moving along the road or an area in which recognition of signal lamps is impossible because of a position of the signal lamp or a view hidden by a preceding vehicle while a vehicle is moving along the road.

The autonomous driving apparatus may further include a generalization unit for generalizing a driving path of a driver inside the vehicle, wherein the context determination main control unit controls the autonomous driving of the vehicle based on results of the generalization of the path of the driver.

The generalization unit may not generalize the path of the driver if a static obstacle is detected because of road construction ahead of the vehicle and thus the driver changes lanes and does not proceed along a planned path.

The generalization unit may generalize the path of the driver if a dynamic obstacle is detected in the path of the driver.

The generalization unit may not generalize the path of the driver if there is no obstacle ahead of the vehicle or if an obstacle, such as a frozen road section, is not detected.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating the concept of autonomous driving in reliable sections according to an embodiment of the present invention;

FIG. 3 is a schematic diagram illustrating an environment to which an autonomous driving apparatus for a vehicle according to an embodiment of the present invention has been applied;

FIG. 4 is a diagram showing the configuration of the autonomous driving apparatus for a vehicle according to an embodiment of the present invention;

FIG. 5 is a diagram showing the configuration of a driver terminal according to an embodiment of the present invention;

FIG. 6 is a diagram showing the configuration of an autonomous driving sharing server according to an embodiment of the present invention;

FIG. 7 is a flowchart illustrating a method of determining a reliable section based on autonomous driving data according to an embodiment of the present invention;

FIGS. 8 to 10 are diagrams illustrating methods of generalizing the driving path of a driver according to embodiments of the present invention;

FIGS. 11 and 12 are flowcharts illustrating an autonomous driving method of a vehicle according to an embodiment of the present invention; and

FIG. 13 is a diagram illustrating an example in which the autonomous driving method for a vehicle has been applied according to an embodiment of the present invention.

### DESCRIPTION OF THE PREFERRED EMBODIMENTS

The present invention will be described below in detail with reference to the accompanying drawings. Here, repetitive descriptions and detailed descriptions of well-known functions or configurations which would unnecessarily obscure the gist of the present invention will be omitted. Embodiments of the present invention are provided to complete the explanation for those skilled in the art of the present invention. Therefore, the shapes and sizes of components in the drawings may be exaggerated to provide more precise descriptions.

An autonomous driving apparatus and method for a vehicle according to embodiments of the present invention will be described in detail below with reference to the accompanying drawings.

First, the term “autonomous driving” refers to a driving method of autonomously determining the driving path of a vehicle based on the results of the recognition of a surrounding environment around the vehicle and then controlling the vehicle so that the vehicle is driven along the determined driving path.

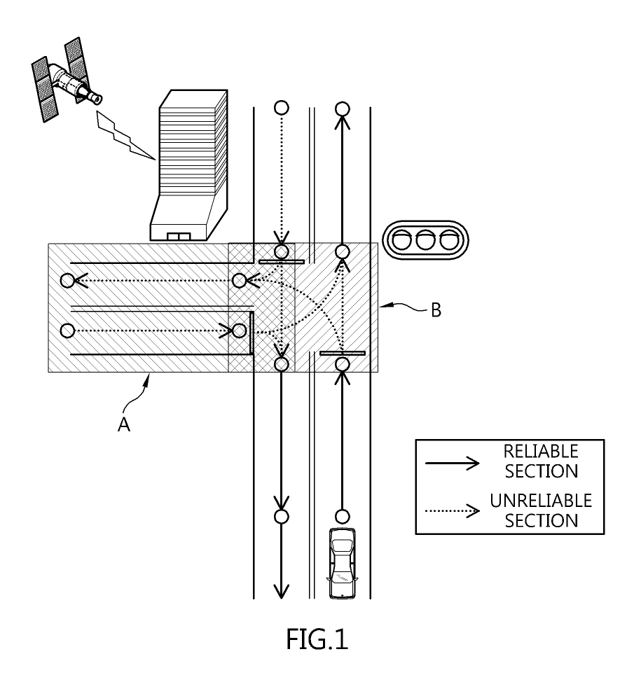

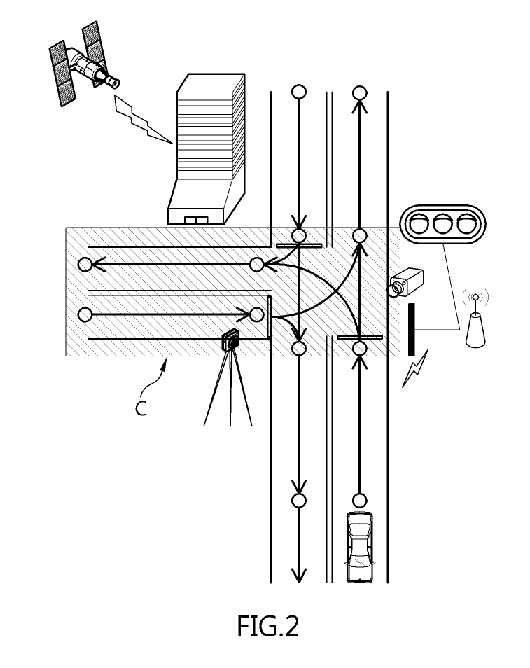

FIGS. 1 and 2 are diagrams illustrating the concept of autonomous driving in reliable sections according to an embodiment of the present invention.

A reliable section corresponds to a spatial-temporal section in which autonomous driving context data, such as recognition information or map information, satisfies conditions required to perform autonomous driving on a specific road. Here, the required conditions include the case where a resulting sensor value can be used, the case where a recognized resulting value falls within a set error range, and the case where map information matches a real road.

For example, there is a high possibility that the sections of a national road and an expressway, which are well maintained and are high in openness in the time spans and under weather conditions in which vehicle position information and sensing information can be easily obtained, may be more reliable than those in the heart of the city where there are lots of buildings, various signals, and lots of vehicles on real roads.

Autonomous driving context data for a reliable section corresponds to all the data which is required when a vehicle drives autonomously. This autonomous driving context data is gathered for specific time and space spans, and is used to determine a reliable section via simulation or to perform real autonomous driving.

The autonomous driving context data includes the data gathering time and position, a GPS context (e.g., the number of satellites and the error rate), lane recognition information (e.g., the lane recognition rate), matching with stored 3D map information (e.g., the number of lanes and the road curvature), static/dynamic obstacle detection information, signal lamp recognition information (e.g., a signal lamp position and the signal recognition rate), signpost recognition information (e.g., the speed limit/turn restriction signpost position, and the speed limit/turn restriction signpost recognition rate), weather, the average driving speed of each link, and driver manipulation information (e.g., information about steering wheel manipulation and acceleration/deceleration manipulation).

A method of gathering the autonomous driving context data includes a first method of gathering the autonomous driving context data using sensors mounted on a vehicle when a driver is driving through a relevant section and a second method of gathering autonomous driving context data required to perform autonomous driving in a specific section from a reliable management server.

Referring to FIG. 1, unreliable sections correspond to a GPS shadow region A in which the reception of GPS signals is impossible while a vehicle is travelling and an area B in which the recognition of a signal lamp is impossible because of the position of the signal lamp or a view hidden by a preceding vehicle while a vehicle is travelling.

When a driver uses an autonomous driving apparatus for a vehicle according to an embodiment of the present invention through these unreliable sections, the vehicle may autonomously drive in a reliable section and then should hand over the control of the vehicle to the driver before entering one of the unreliable sections. Thereafter, when the vehicle moves out of the unreliable section and into a reliable section, the vehicle may drive autonomously.

Referring to FIG. 2, in the present invention, in order to overcome the problems with those unreliable sections, such as that described in conjunction with FIG. 1, a specific infrastructure is installed in a relevant area and then provides reliable and autonomous driving context data to a vehicle. Here, the specific infrastructure may provide information about a detailed map of the relevant area, information about the position of the vehicle, and signal information to the vehicle via wireless communication so that the unreliable sections can become reliable sections. Accordingly, the vehicle may drive autonomously through all sections.

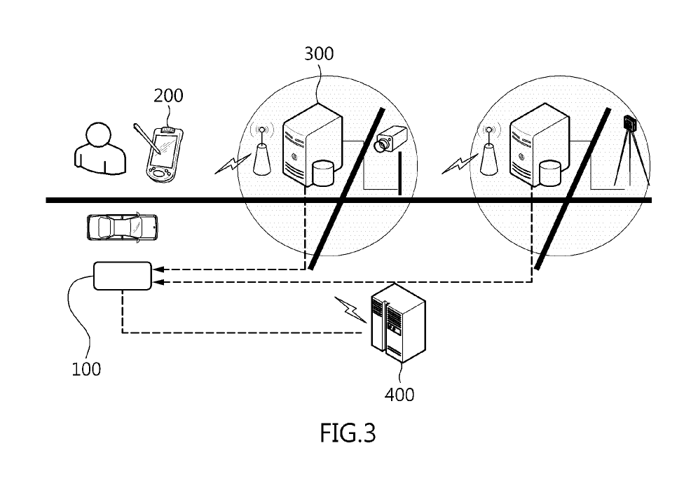

An environment to which the autonomous driving apparatus for a vehicle has been applied will now be described in detail with reference to FIG. 3.

FIG. 3 is a schematic diagram illustrating an environment to which an autonomous driving apparatus for a vehicle according to an embodiment of the present invention has been applied.

Referring to FIG. 3, an environment in which the autonomous driving apparatus for a vehicle according to the embodiment of the present invention has been applied includes an autonomous driving apparatus 100 for a vehicle, a driver terminal 200, an autonomous driving context data server 300, and an autonomous driving sharing server 400.

The autonomous driving apparatus 100 for a vehicle is mounted on a vehicle, and is configured to gather autonomous driving context data, determine the reliable sections of a road based on the gathered autonomous driving context data, and record a reliable path corresponding to the reliable sections. Thereafter, the autonomous driving apparatus 100 for a vehicle determines an autonomous driving context for the vehicle based on the reliable sections and the reliable path, and controls the driving apparatus (not shown) of the vehicle based on the results of the determination.

The driver terminal 200 is a terminal that is held by a driver, and provides the driver with map information. Furthermore, the driver terminal 200 enables the driver to select the driving mode of the vehicle. Here, the driving mode of the vehicle includes manual driving mode and autonomous driving mode. Manual driving mode is a mode in which a vehicle driver should drive the vehicle himself or herself, and autonomous driving mode is a mode in which the driving path of the vehicle is autonomously set based on the results of the recognition of an environment around the vehicle and the vehicle is controlled according to the determined driving path.

The driver terminal 200 operates in conjunction with the autonomous driving apparatus 100 for a vehicle over a WLAN or a Bluetooth network when a driver selects the driving mode of a vehicle to autonomous driving mode.

The autonomous driving context data server 300 may be installed in a necessary place, such as a GPS shadow region in which a GPS system do not work, a tunnel, or an intersection. The autonomous driving context data server 300 transfers autonomous driving context data to the autonomous driving apparatus 100 for a vehicle via Vehicle To Infrastructure (V2I) communication.

For example, the autonomous driving context data server 300 recognizes the position of a vehicle and the position of an obstacle using a camera and Light Detection And Ranging (Lidar) which are installed in an infrastructure, and provides the results of the recognition to the autonomous driving apparatus 100 for a vehicle. Furthermore, the autonomous driving context data server 300 provides the 3D map and position recognition information of an area to the autonomous driving apparatus 100 for a vehicle using a broadcasting or 1-to-1 communication method.

The autonomous driving sharing server 400 shares autonomous driving context data among vehicles, and is connected to the autonomous driving apparatus 100 for a vehicle over a mobile communication network, such as a 3G or 4 G communication network.

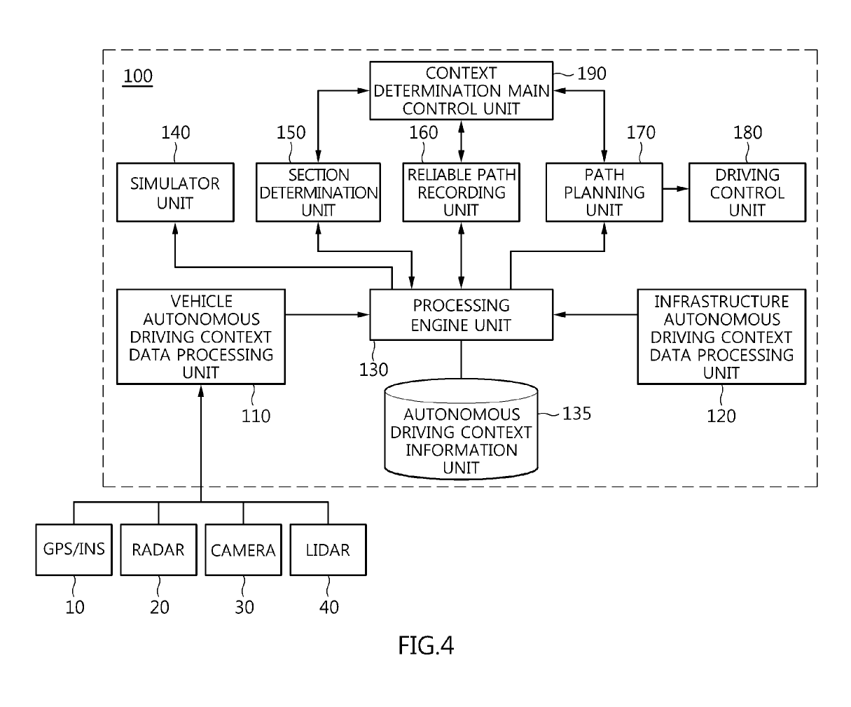

The autonomous driving apparatus 100 for a vehicle will now be described in detail below with reference to FIG. 4.

FIG. 4 is a diagram showing the configuration of the autonomous driving apparatus 100 for a vehicle according to an embodiment of the present invention.

Referring to FIG. 4, the autonomous driving apparatus 100 for a vehicle operates in conjunction with a GPS/INS 10 for recognizing the position of a vehicle, a Radar 20 for recognizing static/dynamic obstacles and roads (e.g., lanes and signals), a camera 30, and a Lidar 40. Furthermore, the autonomous driving apparatus 100 for a vehicle operates in conjunction with a steering wheel angle sensor, an encoder, and an odometer, thereby being able to improve the accuracy of the manipulation of a driver and the accuracy of the recognition of the position of a vehicle.

The autonomous driving apparatus 100 for a vehicle includes a vehicle autonomous driving context data processing unit 110, an infrastructure autonomous driving context data processing unit 120, a processing engine unit 130, an autonomous driving context information unit 135, a simulator unit 140, a section determination unit 150, a reliable path recording unit 160, a path planning unit 170, a driving control unit 180, and a context determination main control unit 190.

The vehicle autonomous driving context data processing unit 110 transfers the results of recognition, that is, autonomous driving context data, received from the GPS/INS 10, the Radar 20, the camera 30 and the Lidar 40 to the processing engine unit 130.

The infrastructure autonomous driving context data processing unit 120 receives autonomous driving context data from the infrastructure, and transfers the received results to the processing engine unit 130.

The processing engine unit 130 stores autonomous driving context data, gathered by the vehicle autonomous driving context data processing unit 110 and the infrastructure autonomous driving context data processing unit 120, in the autonomous driving context information unit 135. Furthermore, the processing engine unit 130 may classify autonomous driving context data into 3D map data, network data for path searches, a sensor data stream and attribute data, and manage the classified data.

The simulator unit 140 simulates the autonomous driving of the vehicle based on the autonomous driving context data. The simulator unit 140 may simulate the autonomous driving of the vehicle to determine whether the autonomous driving of the vehicle is possible.

The section determination unit 150 determines whether a section of a road is reliable or unreliable based on the results of the simulation performed by the simulation unit 140. Furthermore, the section determination unit 150 stores the results of the determination of the reliable and unreliable sections of the road in the autonomous driving context information unit 135.

The reliable path recording unit 160 generalizes the driving path of the driver and records the results of the generalization.

The path planning unit 170 searches for a global path and a local path, and plans the path of the vehicle based on the results of a search performed by the driving control unit 180. Here, the global path corresponds to at least one path along which a vehicle may travel from the current position of the vehicle to a set destination. Furthermore, the local path corresponds to a path which is most suitable for autonomous driving which is obtained by running a simulation based on a global path.

The context determination main control unit 190 operates in conjunction with the driver terminal 200, and controls the autonomous driving of a vehicle in response to a request from a driver received via the driver terminal 200 and based on the driving context of the vehicle.

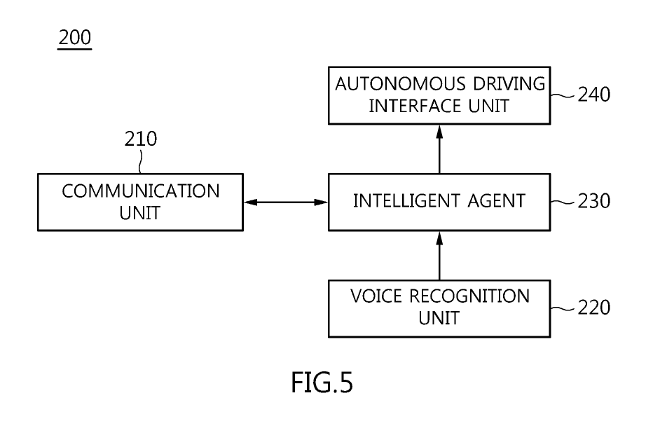

The driver terminal 200 will now be described in detail below with reference to FIG. 5.

FIG. 5 is a diagram showing the configuration of the driver terminal 200 according to an embodiment of the present invention.

Referring to FIG. 5, the driver terminal 200 includes a communication unit 210, a voice recognition unit 220, an intelligent agent 230, and an autonomous driving interface unit 240.

The communication unit 210 communicates with the autonomous driving apparatus 100 for a vehicle.

The voice recognition unit 220 recognizes the voice commands of the driver.

The intelligent agent 230 provides the driver with information about the driving mode of the vehicle set by the autonomous driving apparatus 100 for a vehicle, and transfers the voice command of the driver to the autonomous driving apparatus 100 for the vehicle via the communication unit 210.

The autonomous driving interface unit 240 provides the driver with various screen interfaces, such as path information.

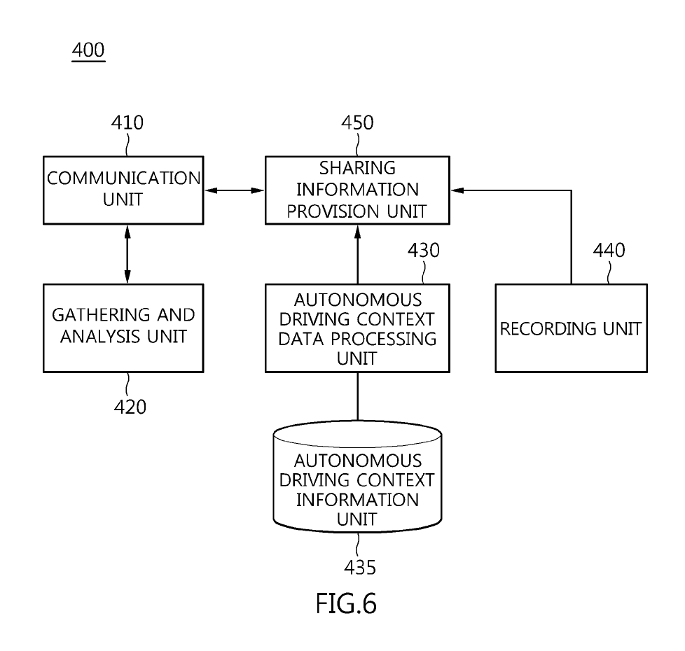

The autonomous driving sharing server 400 will now be described in detail below with reference to FIG. 6.

FIG. 6 is a diagram showing the configuration of the autonomous driving sharing server 400 according to an embodiment of the present invention.

Referring to FIG. 6, the autonomous driving sharing server 400 includes a communication unit 410, a gathering and analysis unit 420, an autonomous driving context data processing unit 430, an autonomous driving context information unit 435, a recording unit 440, and a sharing information provision unit 450.

The communication unit 410 communicates with the autonomous driving apparatus 100 for a vehicle over a mobile communication network.

The gathering and analysis unit 420 determines all reliable sections and the reliability of the reliable sections based on the autonomous driving context data and reliable section information received from the autonomous driving apparatus 100, and transfers information about all the reliable sections and the reliability of the reliable sections to the autonomous driving context data processing unit 430.

The autonomous driving context data processing unit 430 provides autonomous driving context data corresponding to an external request. Furthermore, the autonomous driving context data processing unit 430 stores autonomous driving context data, all reliable sections and the reliability of the reliable sections, determined based on the autonomous driving context data and the reliable section information, in the autonomous driving context information unit 435.

The recording unit 440 records metadata corresponding to the position of the autonomous driving context data server 300, the size of a service provision area in which autonomous driving context data may be provided, and the type of data provided.

The sharing information provision unit 450 shares autonomous driving context data for each vehicle, and provides sharing information to the autonomous driving apparatus of a vehicle.

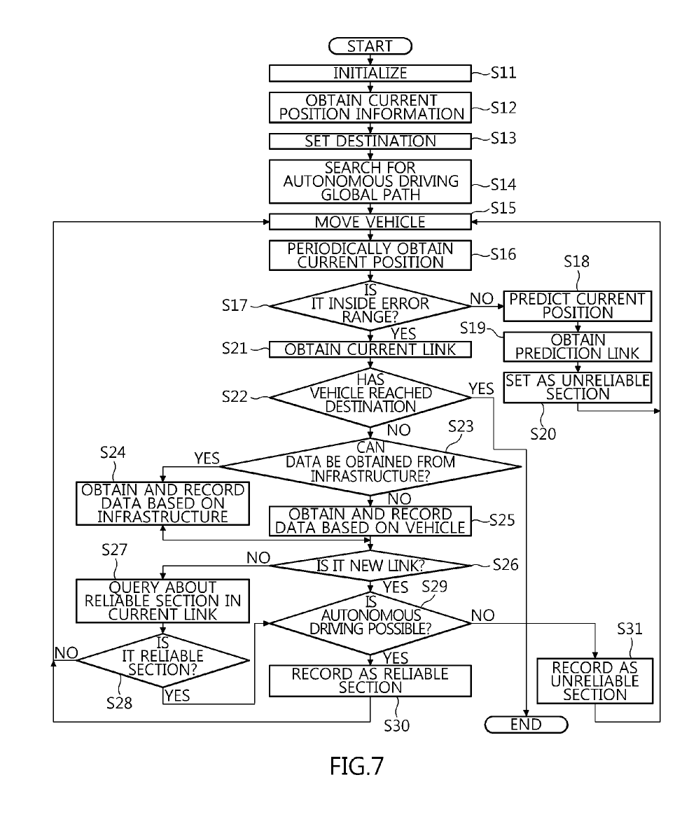

A method by which the autonomous driving apparatus 100 for a vehicle determines a reliable section based on autonomous driving data will now be described in detail below with reference to FIG. 7.

FIG. 7 is a flowchart illustrating the method of determining a reliable section based on autonomous driving data according to an embodiment of the present invention.

Referring to FIG. 7, the autonomous driving apparatus 100 for a vehicle initializes all the pieces of its information, all recognition results, and all communication histories at step S11.

The autonomous driving apparatus 100 for a vehicle obtains current position information using the GPS/INS 10 or the external infrastructure at step S12.

The autonomous driving apparatus 100 for a vehicle receives the destination of the driver via the driver terminal 200 and uses the received destination to set the destination at step S13.

The autonomous driving apparatus 100 for a vehicle searches for an autonomous driving global path (e.g., a node and link level path) from the current position to the set destination at step S14. Here, the autonomous driving apparatus 100 for a vehicle may search for a global path, and simulate the autonomous driving of a vehicle based on the retrieved global path. Furthermore, the autonomous driving apparatus 100 for a vehicle may naturally gather autonomous driving context data by searching for the global path if a driver uses a conventional navigator.

The autonomous driving apparatus 100 for a vehicle provides the autonomous driving global path to a driver, so that a vehicle travels along the autonomous driving global path at step S15.

When the vehicle travels along the autonomous driving global path, the autonomous driving apparatus 100 for a vehicle periodically obtains the current position from the sensors of the vehicle or infrastructure at step S16.

The autonomous driving apparatus 100 for a vehicle determines whether the obtained current position falls within a set error range at step S17.

If the current position may not be periodically obtained at step S16 or if, as a result of the determination at step S17, it is determined that the obtained current position does not fall within the set error range, the autonomous driving apparatus 100 for a vehicle predicts the current position by applying the current position information, obtained at step S12, to a method, such as a Kalman filter, at step S18. The autonomous driving apparatus 100 for a vehicle obtains matching results, that is, a prediction link by matching the predicted current position with a map at step S19. Thereafter, the autonomous driving apparatus 100 for a vehicle sets the obtained prediction link as an unreliable section at step S20.

If, as a result of the determination at step S17, it is determined that the obtained current position falls within the set error range, the autonomous driving apparatus 100 for a vehicle obtains matching results, that is, a current link by matching the current position, periodically obtained at step S16, with a map at step S21. Here, the current link corresponds to a link in road network data.

The autonomous driving apparatus 100 for a vehicle determines whether the current position periodically obtained at step S16 is within a specific distance away from the destination at step S22. If, as a result of the determination at step S22, it is determined that the current position periodically obtained at step S16 is within the specific distance, the autonomous driving apparatus 100 for a vehicle determines that the vehicle has arrived at the destination and terminates the process of periodically obtaining the current position.

If, as a result of the determination at step S22, it is determined that the current position periodically obtained at step S16 is not within the specific distance to the destination, the autonomous driving apparatus 100 for a vehicle determines whether autonomous driving context data may be obtained from the infrastructure at step S23.

If, as a result of the determination at step S23, it is determined that autonomous driving context data can be obtained from the infrastructure, the autonomous driving apparatus 100 for a vehicle obtains and record the autonomous driving context data based on the infrastructure at step S24.

If, as a result of the determination at step S23, it is determined that autonomous driving context data cannot be obtained from the infrastructure, the autonomous driving apparatus 100 for a vehicle obtains and records autonomous driving context data based on the sensors of the vehicle at step S25.

The autonomous driving apparatus 100 for a vehicle determines whether a current link corresponds to a new link different from the current link obtained at the previous step S26.

If, as a result of the determination at step S25, it is determined that the current link does not correspond to a new link, the autonomous driving apparatus 100 for a vehicle determines whether there is a reliable section in the current link at step S27. At step S28, the autonomous driving apparatus 100 for a vehicle queries whether there is a reliable section in the current link based on the results of the query at step S27. If, as a result of the determination at step S28, it is determined that there is no reliable section in the current link, that is, there is no unreliable section in the current link, the autonomous driving apparatus 100 for a vehicle returns to step S15. With respect to a current link determined to have an unreliable section as described above, whether a reliable section is present is not queried again.

If, as a result of the determination at step S28, it is determined that a reliable section is present in the current link or if, as a result of the determination at step S26, it is determined that the current link corresponds to a new link, the autonomous driving apparatus 100 for a vehicle simulates whether autonomous driving is possible based on the autonomous driving context data, obtained at step S24 or S25, at step S29. More particularly, at step S29, the autonomous driving apparatus 100 for a vehicle may determine whether autonomous driving is possible by determining whether recognition information is present inside a set error range, whether recognition information is identical with an internal detailed map, and whether a set simulation result, and the driving trajectory and acceleration and deceleration of a driver fall within threshold values (e.g., if a road has been changed because of road construction, if it is determined that there is an obstacle but a driver has passed by the obstacle, or if sudden braking is applied at a point where there is no reason to apply a brake suddenly) in the simulation process. If, as a result of the determination at step S29, it is determined that autonomous driving is possible based on the autonomous driving context data, the autonomous driving apparatus 100 for a vehicle records the new link as a reliable section at step S30. If, as a result of the determination at step S29, it is determined that autonomous driving is not possible based on the autonomous driving context data, the autonomous driving apparatus 100 for a vehicle records the new link as an unreliable section at step S31.

The method of determining a reliable section based on autonomous driving data as described above is problematic in that full reliability is difficult to obtain because a reliable section can be determined only on a road that a driver has visited and a spatial-temporal section in which autonomous driving is possible is very limited. However, if vehicles on each of which the autonomous driving apparatus 100 for a vehicle is mounted share reliable section information, the reliability and range of reliable sections can be expanded.

That is, count information for each section recorded as a reliable section by a plurality of autonomous driving apparatuses for a vehicle may be maintained, and the reliability of the section may be measured based on the count information. Furthermore, whether a section that has not been visited by a vehicle is a reliable section may be determined by sharing reliable sections among vehicles.

For this purpose, the autonomous driving apparatus for a vehicle may upload information about sensors mounted on a vehicle and vehicle control information, together with autonomous driving context data and reliable section determination data, into the autonomous driving sharing server 400 so that autonomous driving context data and reliable section determination data owned by vehicles having similar sensors and vehicle control information may be shared.

The autonomous driving apparatus 100 for a vehicle may determine a reliable section based on autonomous driving data, and calculate the autonomous driving path of the vehicle in real time based on information about the determined reliable section. Furthermore, the autonomous driving apparatus 100 for a vehicle may record a path along which a driver has moved so that autonomous driving can track the recorded path. In the method, driving which is similar to the driving pattern of a driver and which is more predictable is made possible because the autonomous driving tracks a driving path along which a driver has moved.

A problem which occurs when the driving path of a driver is recorded is that the driver may travel along another path in subsequent driving depending on driving conditions. For this reason, it is required for the autonomous driving apparatus 100 for a vehicle to generalize a driving path which is recorded depending on the driving conditions of a driver. The generalization of the driving path may reduce unnecessary lane change, increase driving safety, and reduce the danger of a collision.

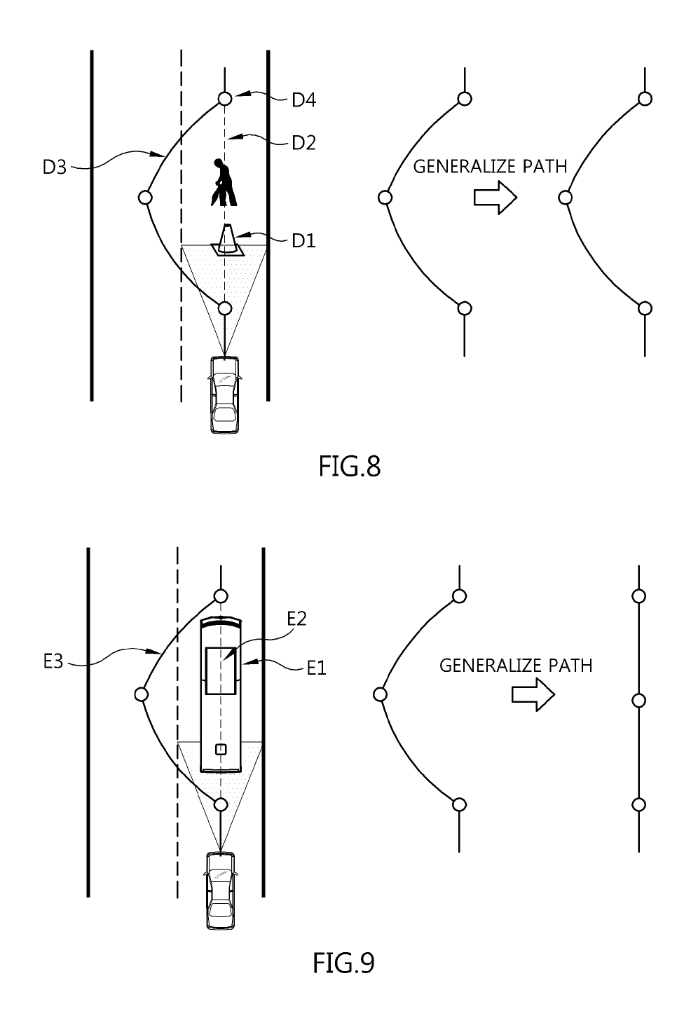

Some methods by which the autonomous driving apparatus 100 for a vehicle generalizes the driving path of a driver will now be described in detail with reference FIGS. 8 to 10.

FIGS. 8 to 10 are diagrams illustrating methods of generalizing the driving path of a driver according to embodiments of the present invention.

First, the method of generalizing the driving path of a driver may differ depending on the type of obstacle.

FIG. 8 shows a method of generalizing a driving path when a static obstacle D1 is detected in the driving path of a driver.

If the autonomous driving apparatus 100 for a vehicle detects a static obstacle D1 because of road construction ahead and thus a driver changes lanes without using a path D2 planned by the driver as in FIG. 8, the autonomous driving apparatus 100 for a vehicle does not generalize a driving path and records the real driving path D3 of the driver without change. Here, the autonomous driving apparatus 100 for a vehicle does not generalize the real driving path D3 of the driver based on the planned path D2 because the static obstacle D1 may affect subsequent driving such as that through a road construction section.

FIG. 9 shows a method of generalizing a driving path when a dynamic obstacle E1 is detected in the driving path of a driver.

If the autonomous driving apparatus 100 for a vehicle detects a dynamic obstacle E1, for example, a slow-moving preceding vehicle, and thus a driver changes lanes, as in FIG. 9, the autonomous driving apparatus 100 for a vehicle generalizes the real driving path E3 of the driver based on a path E2. Here, if a section in which the driver changes lanes is not a section in which the lanes can be recognized or is not within the distance where dead reckoning is possible or is already determined not to be a reliable section, the real driving path E3 of the driver is not generalized. That is, a section in which the real driving path E3 of the driver is generated is generalized only when the section has already been verified or is within an area in which further autonomous driving is possible.

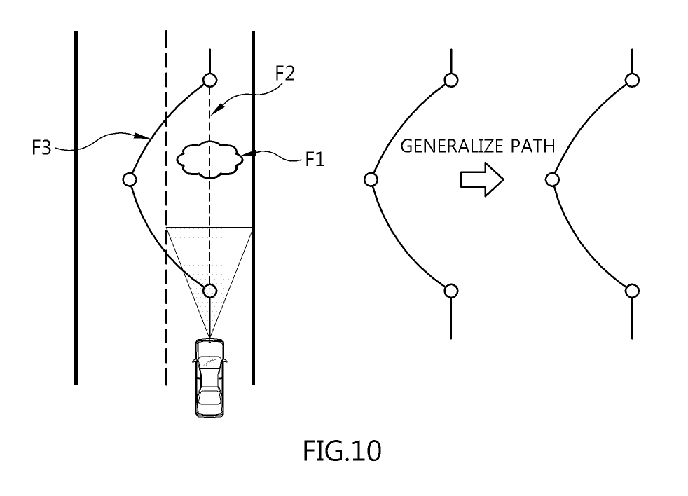

FIG. 10 shows a method of generalizing a driving path of a driver when no obstacle is detected in the driving path.

If there is no obstacle ahead of a vehicle or the autonomous driving apparatus 100 for a vehicle does not detect an obstacle F1, such as a frozen road section, as in FIG. 10, the autonomous driving apparatus 100 for a vehicle does not generalize the real driving path F3 of a driver based on a planned path F2.

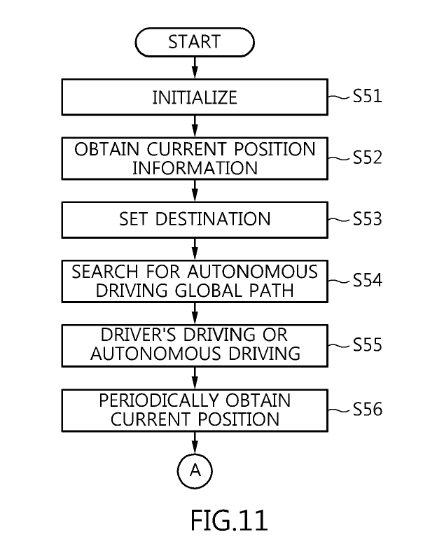

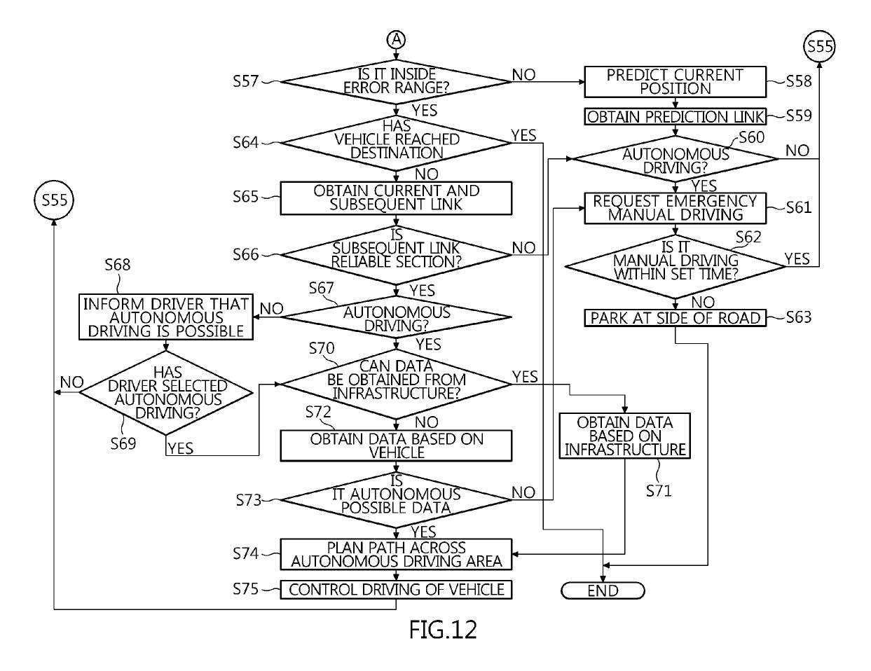

An autonomous driving method for a reliable section will now be described in detail with reference to FIGS. 11 and 12. The autonomous driving method for a reliable section is similar to the method of determining a reliable section in FIG. 7, but differs from the method of FIG. 7 in that a vehicle is controlled and the driving mode of a vehicle is selected without running a simulation to determine whether autonomous driving is possible.

FIGS. 11 and 12 are flowcharts illustrating an autonomous driving method for a vehicle according to an embodiment of the present invention.

Referring to FIG. 11, the autonomous driving apparatus 100 for a vehicle initializes all pieces of its information, all recognition results, and the entire communication history at step S51.

The autonomous driving apparatus 100 for a vehicle obtains current position information using the GPS/INS 10 or the external infrastructure at step S52.

The autonomous driving apparatus 100 for a vehicle receives the destination of a driver via the driver terminal 200 and uses the received destination to set a destination at step S53.

The autonomous driving apparatus 100 for a vehicle searches for an autonomous driving global path (e.g., a node and link level path) from the current position to the set destination at step S54. Here, if a reliable path from the current position to the set destination is present, the autonomous driving apparatus 100 for a vehicle uses the reliable path as an autonomous driving global path.

The vehicle is moved by the driver or via autonomous driving based on the autonomous driving global path retrieved by the autonomous driving apparatus 100 for a vehicle at step S55.

If the vehicle moves along the autonomous driving global path, the autonomous driving apparatus 100 for a vehicle periodically obtains a current position from sensors of the vehicle or the infrastructure at step S56.

Referring to FIG. 12, the autonomous driving apparatus 100 for a vehicle determines whether the obtained current position falls within a set error range at step S57.

If the current position may not be periodically obtained at step S56 or if, as a result of the determination at step S57, it is determined that the obtained current position falls within the set error range, the autonomous driving apparatus 100 for a vehicle estimates the current position by applying the current position information, obtained at step S52, to a method, such as a Kalman filter, at step S58. The autonomous driving apparatus 100 for a vehicle obtains matching results, that is, a prediction link, by matching the predicted current position with a map at step S59. Thereafter, the autonomous driving apparatus 100 for a vehicle determines whether the vehicle is now moving under autonomous driving at step S60. If, as a result of the determination at step S60, it is determined that the vehicle is now moving under autonomous driving, the autonomous driving apparatus 100 for a vehicle requests manual driving from the driver via the driver terminal 200 at step S61. Thereafter, the autonomous driving apparatus 100 for a vehicle determines whether the vehicle is being manually moved by the driver within a set time at step S62. If, as a result of the determination at step S62, it is determined that the vehicle is not being manually moved by the driver within the set time, the autonomous driving apparatus 100 for a vehicle automatically parks the vehicle at a side of a road at step S63. Here, the autonomous driving apparatus 100 for a vehicle informs the driver that the current position of the vehicle is a dangerous point. If there is no side of a road, the autonomous driving apparatus 100 for a vehicle controls the vehicle so that the vehicle moves to a section in which autonomous driving is possible at low speed.

If, as a result of the determination at step S57, it is determined that the obtained current position falls within the set error range, the autonomous driving apparatus 100 for a vehicle determines whether the vehicle has reached the destination based on the results of the matching the current position, periodically obtained at step S56, with the map at step S64. If, as a result of the determination at step S64, it is determined that the vehicle has reached the destination, the autonomous driving apparatus 100 for a vehicle terminates the process of periodically obtaining the current position. In contrast, if, as a result of the determination at step S64, it is determined that the vehicle has not reached the destination, the autonomous driving apparatus 100 for a vehicle obtains a current link and a subsequent link at step S65. Here, the current link and the subsequent link correspond to links which are present in road network data.

The autonomous driving apparatus 100 for a vehicle determines whether the subsequent link corresponds to a reliable section at step S66. If, as a result of the determination at step S66, it is determined that the subsequent link does not correspond to a reliable section, the autonomous driving apparatus 100 for a vehicle proceeds to step S60. If, as a result of the determination at step S66, it is determined that the subsequent link corresponds to a reliable section, the autonomous driving apparatus 100 for a vehicle determines whether the vehicle is now moving under autonomous driving at step S67.

If, as a result of the determination at step S67, it is determined that the vehicle is now moving under autonomous driving, the autonomous driving apparatus 100 for a vehicle informs the driver that a current area is an area in which autonomous driving is possible via the driver terminal 200 at step S68. The autonomous driving apparatus 100 for a vehicle informs the driver that a current area is an area in which autonomous driving is possible as at step S68 so that the driver may select autonomous driving at step S69.

If, as a result of the determination at step S69, it is determined that the driver has selected autonomous driving or if, as a result of the determination at step S67, it is determined that the vehicle is now moving under autonomous driving, the autonomous driving apparatus 100 for a vehicle determines whether autonomous driving context data may be obtained from the infrastructure at step S70.

If, as a result of the determination at step S70, it is determined that autonomous driving context data is able to be obtained from the infrastructure, the autonomous driving apparatus 100 for a vehicle obtains autonomous driving context data based on the infrastructure at step S71. If, as a result of the determination at step S70, it is determined that autonomous driving context data is not able to be obtained from the infrastructure, the autonomous driving apparatus 100 for a vehicle obtains autonomous driving context data using sensors of the vehicle at step S72.

The autonomous driving apparatus 100 for a vehicle simulates whether autonomous driving is possible based on the autonomous driving context data, obtained at step S72, at step S73. If, as a result of the determination at step S72, it is determined that autonomous driving is not possible based on the autonomous driving context data, the autonomous driving apparatus 100 for a vehicle requests manual driving from the driver via the driver terminal 200 at step S61.

If, as a result of the determination at step S72, it is determined that autonomous driving is possible based on the autonomous driving context data, the autonomous driving apparatus 100 for a vehicle plans an autonomous driving local path based on the results of the simulation at step S74. Here, the autonomous driving local path corresponds to the trajectory of the vehicle in which obstacles within a specific distance from the position of the vehicle are avoided, and it is a path which is most suitable for autonomous driving which has been obtained from the simulation.

The autonomous driving apparatus 100 for a vehicle controls the driving of the vehicle along the planned autonomous driving local path at step S75 so that the vehicle is autonomously driven.

An algorithm corresponding to an autonomous driving method for a vehicle, such as that shown in FIGS. 11 and 12, may search for a path using the Dijkstra algorithm or the A* algorithm which is used in a conventional navigator. The result, such as the shortest distance or the minimum time path, may be obtained depending on how much the link costs are for the network data.

Since autonomous driving is the purpose of the present invention, a driver may desire a path including a maximum number of autonomous driving sections, rather than a shortest path in terms of distance or time. In this case, if link costs are calculated as driver work load costs according to Equation 1, the maximum autonomous driving path may be searched for:

Link cost=(distance or time of each link)×(autonomous driving factor) (1)

where the autonomous driving factor is 1 if a section is an unreliable section or a non-determined section, and the autonomous driving factor is a number <1, which is determined according to autonomous driving preferences, if a section is a reliable section.

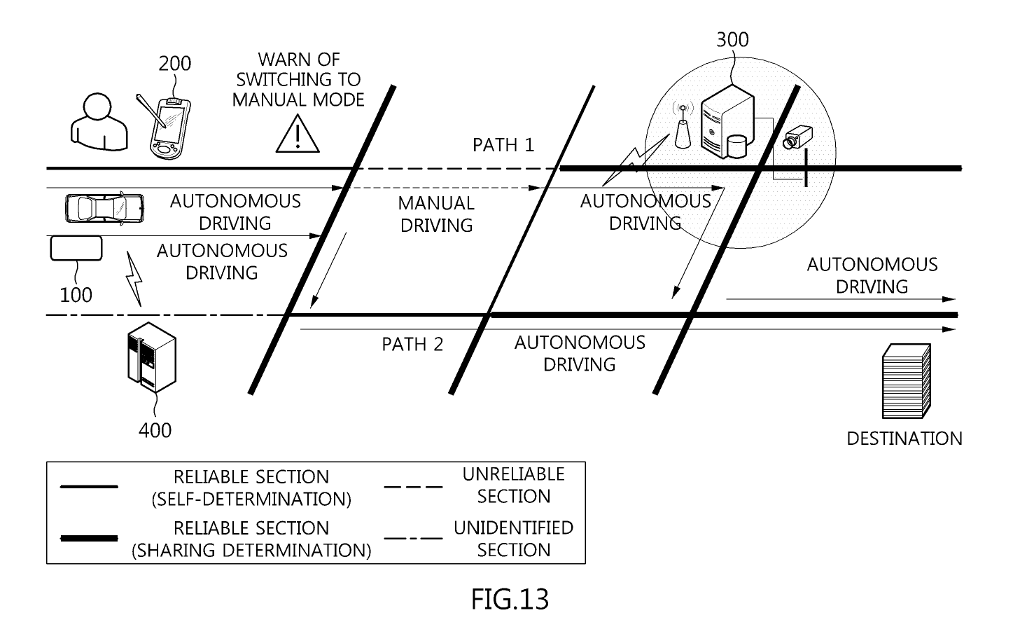

An example in which an autonomous driving method for a vehicle, such as that shown in FIGS. 11 and 12, has been applied will now be described in detail with reference to FIG. 13.

FIG. 13 is a diagram illustrating an example in which the autonomous driving method for a vehicle has been applied according to an embodiment of the present invention.

Referring to FIG. 13, a thin solid line indicates a section which is determined to be a reliable section as a result of direct driving by a driver, and thick solid lines indicate sections which are determined by lots of drivers as reliable sections. A dotted line indicates an unreliable section, and a chain-dashed line indicates a section which has not yet been determined to be an unreliable section or a reliable section.

An example in which the autonomous driving method for a vehicle has been applied to a path 1 will now be described.

A driver riding in a vehicle inputs a destination to the driver terminal 200 using his or her voice. The driver terminal 200 provides the driver with information about paths from the current position of the vehicle to the destination via its screen and also provides the driver with information about which of the paths is the path along which autonomous driving is possible.

The driver selects the driving mode of the vehicle from between the manual driving mode and autonomous driving mode. For example, when the driver selects autonomous driving mode as the driving mode of the vehicle and requests autonomous driving mode using his or her voice, the vehicle starts autonomous driving.

If it is determined that a subsequent link is an unreliable section in the state in which the vehicle is being autonomously driven, the autonomous driving apparatus 100 for a vehicle requests that the driver switch the driving mode of the vehicle to manual driving mode via the driver terminal 200. In response to the request, the driver switches the driving mode of the vehicle to manual driving mode and drives the vehicle by himself.

When the vehicle enters a reliable section again, the autonomous driving apparatus 100 for a vehicle informs the driver that autonomous driving is possible. Accordingly, the autonomous driving apparatus 100 for a vehicle may perform control so that autonomous driving is made to the destination in autonomous driving mode.

Furthermore, when a driver says a destination and selects maximum reliable section driving as the path search option, the autonomous driving apparatus 100 for a vehicle searches for a path 2 along which there is the maximum autonomous driving although more time is taken so that full autonomous driving is made to the destination.

In accordance with the embodiments of the present invention, the autonomous driving apparatus and method for a vehicle set a reliable section determined to be a section in which the autonomous driving of a vehicle is possible, and autonomously drive a vehicle in the set reliable section without intervention of a driver. Accordingly, the safety of autonomous driving can be improved. Furthermore, in accordance with the present invention, the driving path of a driver can be recorded, and the vehicle can be autonomously driven along a path preferred by the driver based on the recording.

Furthermore, in accordance with the embodiments of the present invention, the autonomous driving apparatus and method for a vehicle can be usefully applied to the field of freight transportation that requires long-distance driving over repetitive sections.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An autonomous driving method for a vehicle, comprising:
obtaining a current position of the vehicle and setting a destination of the vehicle;
searching paths, ranging from the current position of the vehicle to the destination, for an autonomous driving global path having a reliable section;
periodically obtaining a position of the vehicle moving along the autonomous driving global path;
if the obtained position falls within a set error range, determining whether the vehicle has reached the destination based on results of matching the position of the vehicle with a map;
if, as a result of the determination, it is determined that the vehicle has not reached the destination, obtaining a current link and a subsequent link of the vehicle and determining whether the subsequent link corresponds to the reliable section; and
if, as a result of the determination, it is determined that the subsequent link is the reliable section, controlling driving of the vehicle so that the vehicle is moved by autonomous driving.

2. The autonomous driving method as set forth in claim 1, wherein the reliable section corresponds to a spatial-temporal section in which autonomous driving context data obtained on a specific road satisfies conditions required for the autonomous driving.

3. The autonomous driving method as set forth in claim 2, wherein the controlling the driving of the vehicle comprises:
if, as a result of the determination, it is determined that the subsequent link is the reliable section, determining whether the vehicle is now moving under autonomous driving;
if, as a result of the determination, it is determined that the vehicle is now being moved by the autonomous driving, obtaining autonomous driving context data using sensors of the vehicle or from an external infrastructure;
running simulation based on the autonomous driving context data;
planning an autonomous driving local path based on results of the simulation; and
controlling the driving of the vehicle based on the autonomous driving local path.

4. The autonomous driving method as set forth in claim 3, wherein the determining whether the vehicle is now moving under autonomous driving comprises, if, as a result of the determination, it is determined that the vehicle is not now being moved by the autonomous driving, informing a vehicle driver that the vehicle is located in an area in which the autonomous driving is possible.

5. The autonomous driving method as set forth in claim 3, wherein the autonomous driving context data corresponds to data required for the autonomous driving of the vehicle, and comprises at least one of a data gathering time, a gathering position, a Global Positioning System (GPS) context, lane recognition information, matching with stored 3D map information, static/dynamic obstacle detection information, signal lamp recognition information, signpost recognition information, weather, each link average driving speed, and driver manipulation information.

6. The autonomous driving method as set forth in claim 1, further comprising:
if, as a result of the determination, it is determined that the periodically obtained position falls within the set error range, obtaining a prediction link based on the results of matching the position of the vehicle with the map; and
if, as a result of the determination, it is determined that the vehicle is now being moved by the autonomous driving, requesting manual driving from a vehicle driver so that the driver manually drives the vehicle.

7. The autonomous driving method as set forth in claim 6, wherein the requesting the manual driving from the vehicle driver comprises, if the vehicle is not manually moved by the driver within a set time after the manual driving has been requested, controlling the vehicle so that the vehicle is parked at a side of a road.

8. An autonomous driving apparatus for a vehicle, comprising:
an autonomous driving context data processing unit for gathering autonomous driving context data;
a simulator unit for simulating autonomous driving of the vehicle based on the gathered autonomous driving context data;
a section determination unit for determining a reliable section or an unreliable section of a road based on results of the simulation of the autonomous driving of the vehicle;
a path planning unit for searching for at least one global path along which the vehicle moves from a current position to a set destination based on results of the determination of the reliable section or the unreliable section, and searching the at least one global path for a local path along which the autonomous driving is possible; and
a context determination main control unit for controlling the autonomous driving of the vehicle along the local path.

9. The autonomous driving apparatus as set forth in claim 8, wherein the autonomous driving context data corresponds to data required for the autonomous driving of the vehicle, and comprises at least one of a data gathering time, a gathering position, a GPS context, lane recognition information, matching with stored 3D map information, static/dynamic obstacle detection information, signal lamp recognition information, signpost recognition information, weather, each link average driving speed, and driver manipulation information.

10. The autonomous driving apparatus as set forth in claim 8, wherein the autonomous driving context data processing unit comprises:
a vehicle autonomous driving context data processing unit for gathering the autonomous driving context data using sensors of the vehicle; and
an infrastructure autonomous driving context data processing unit for gathering the autonomous driving context data based on an external infrastructure.

11. The autonomous driving apparatus as set forth in claim 8, wherein the reliable section corresponds to a spatial-temporal section in which the autonomous driving context data of the road satisfies conditions required for the autonomous driving.

12. The autonomous driving apparatus as set forth in claim 8, wherein the unreliable section corresponds to a GPS shadow region in which reception of GPS signals is impossible while a vehicle is moving along the road or an area in which recognition of signal lamps is impossible because of a position of the signal lamp or a view hidden by a preceding vehicle while a vehicle is moving along the road.

13. The autonomous driving apparatus as set forth in claim 8, further comprising a generalization unit for generalizing a driving path of a driver inside the vehicle, wherein the context determination main control unit controls the autonomous driving of the vehicle based on results of the generalization of the path of the driver.

14. The autonomous driving apparatus as set forth in claim 13, wherein the generalization unit does not generalize the path of the driver if a static obstacle is detected because of road construction ahead of the vehicle and thus the driver changes lanes and does not proceed along a planned path.

15. The autonomous driving apparatus as set forth in claim 13, wherein the generalization unit generalizes the path of the driver if a dynamic obstacle is detected in the path of the driver.

16. The autonomous driving apparatus as set forth in claim 13, wherein the generalization unit does not generalize the path of the driver if there is no obstacle ahead of the vehicle or if an obstacle, such as a frozen road section, is not detected.
